(19) United States
(12) Patent Application Publication
(10) Pub. No.: US 2008/0314529 A1
(43) Pub. Date: Dec. 25, 2008

(54) VENETIAN BLIND FOR IRREGULARLY SHAPED WINDOW

(76) Inventor: John Milton Coole, Miami, FL (US)

Correspondence Address: John M. Coole, 11394 SW 65th Street, Miami, FL, 33173, US

(21) Appl. No.: 11/767,512

(22) Filed: Jun. 24, 2007

(51) Int. Cl. E06B 9/30

(52) U.S. Cl. 160/168.1 R

(57) ABSTRACT

A venetian blind for an irregularly shaped window, such as a palladian-style window with an arch shaped top, wherein the cord ladders supporting the blind slats are attached to pull-cords, suspended from attachment means fastened directly to the top of the window frame, and routed down through slat cord-slots to an operating mechanism in a base rail fastened to the bottom of the window frame. The blind slat lengths are trimmed to fit the window contour.

### BACKGROUND OF THE INVENTION

1. Field of the Invention

The present invention relates to a horizontal slatted blind, or venetian-style blind, for use with an irregularly shaped window. More specifically, the present invention relates to a venetian blind for use with a window with a non-straight, or non-horizontal top frame; i.e. curved or slanted.

2. Prior Art

Conventional venetian blind window coverings are intended for use with square or rectangular shape windows. A head rail is attached to the horizontal, straight, top frame of the window. The blind is suspended from the head rail, which contains mechanisms to raise and lower the blind, and to tilt, or open and close, the slats to vary the amount of light transmitted. For aesthetic or illumination reasons, architects often design in non-rectangularly shaped windows; e.g. curved or semi-circular, top frame palladian-style windows, arched top frame church-type windows, angled top frame chalet-type windows, etc. Windows with non-straight, or non-horizontal top-frames can not accommodate the conventional venetian blind head rail. For this reason, irregular shape windows are often left uncovered, or only the rectangular portion is covered, leaving the non-rectangular portion uncovered, or covered with a non-matching, non-adjustable window treatment. This may not be desirable for many reasons: aesthetics, illumination, privacy, temperature control, solar fading, energy conservation, etc.

U.S. Pat. No. 6,062,291, Morgan et al., discloses a venetian blind for palladian-style windows. This blind requires the use of a manufactured frame (arch rail) fitted within the window frame, which would add expense, and be aesthetically unattractive. It is not suitable for mounting on the front of the window frame, making it incompatible with many already-installed blinds. The entire device has to be removed to provide access to the window for cleaning or other purposes. And, it is not suitable to cover the entire window; e.g. both the irregular and regular portions of a rectangular window with a palladian-style top.

U.S. Pat. No. 5,632,316, Cohen, discloses a venetian blind for palladian-style windows with slide-able slats that can be extended or retracted to fit the contour of the window. This device, like all other venetian blinds known, uses a head rail to suspend the blind, and to contain the mechanism to raise, lower, and tilt the blind slats. This head rail is straight, and therefore is a poor approximation of the curved window frame, allowing excess light to enter. Because the slats overlap upon themselves to provide for slide-able adjustment, they are not suitable for translucent or “light filtering” blinds, since the double thickness would not transmit light the same as the single thickness. Further, on installations inside window frames, only the rectangular portion of the blind could be raised, since it would interfere with the curved portion of the frame.

U.S. Pat. No. 5,823,241, Sitzes, Turner, discloses a venetian blind for arched windows in two embodiments. The first uses rigid supports, and therefore is actually more like a “plantation” shutter. Further, the slats are fixed in position and therefore can not be slat tilt adjusted or raised/lowered. The second embodiment does use conventional venetian blind cord ladders, but therefore uses a straight headrail which, although short, is still a poor arch approximation. While slat tilt adjustable, this embodiment also can not be raised/lowered.

Many published patents and patent applications disclose blinds for arched windows, but not venetian blinds. They disclose fan type blinds, or pleated blinds, generally. U.S. Patent Application Pub. No.; 2006/0042761 A1, Larsen, is an example.

### SUMMARY OF THE INVENTION

It is the object of the present invention to provide a venetian-blind without a head rail, that can be used on palladian-style windows, as well as other style windows with non-straight, horizontal top frames; that does not require the use of an additional frame within the window frame; that can be installed within the window frame or on the front of it; that can be easily lowered, without removal, to permit access to the window glass; that can be made from the same material and design as already-installed blinds; that is suitable for use with both translucent or opaque blind slats; that can be made to cover only the non-rectangular portion of a window, or easily extended to cover also the rectangular portion, if one exists and it is so desired; that could be manufactured in standard sizes and then trimmed to fit the window shape, thus eliminating expensive custom manufacturing and fitting; and could be provided in progressive levels of usefulness/expense ranging from static only, to slat tilt adjustable, to slat tilt adjustable and able to be raised/lowered.

The present invention accomplishes these objectives by disclosing a venetian blind that is not suspended from a conventional venetian blind straight head rail. Instead, cord ladders are used to suspend slats from points attached directly to the top of the window frame. The slat lengths are trimmed, and the attach points spaced, to fit the contour of the window. Means is provided to tilt the slats, to vary the amount of light transmitted, or to raise or lower the blind, by pull cords attached to the cord ladder tops, and routed over the attach points and back down through slat cord slots to a base rail attached to the bottom of the window frame. No other device is known to provide the advantages of the present invention.

### BRIEF DESCRIPTION OF THE DRAWINGS

FIG. 1 is a front view of a preferred embodiment of a venetian blind for a palladian-style window. The blind is shown in the raised position, and installed inside the window frame.

FIG. 2A is an enlarged, partial, perspective view of the upper portion of the blind in FIG. 1, at a typical attach point; RF,RB.

FIG. 2B is an enlarged, partial, perspective view of the lower portion of the blind in FIG. 1, at the same typical attach point as FIG. 2A, with a section broken out for clarification; as well as a partial view of the lower portion at an adjacent attach point; RCF,RCB.

FIG. 3 is a front view of the blind in FIG. 1, shown in the mid-point position.

FIG. 4 is a front view of the blind in FIG. 1, shown in the lowered position.

FIG. 5 is an enlarged, partial, perspective view of the lower portion of another embodiment of the invention at a typical attach point, with a section broken out for clarification.

FIG. 6 is a front view of a slat tilt adjustable-only venetian blind.

FIG. 7 is a cross section view of the slat tilt mechanism of the blind shown in FIG. 6.

FIG. 8 is a front view of a non-adjustable venetian blind.

FIG. 9 is a cross section view of the bottom section of the blind shown in FIG. 8.

FIG. 10 is a front view of another embodiment of the present invention installed in an arched, church-type window.

FIG. 11 is a front view of another embodiment of the present invention installed in a slanted top, chalet-type window.

FIG. 12 is a front view of the present invention partially covering a palladian-style window together with a conventional-style venetian blind.

FIG. 13 is a front view of the present invention entirely covering a palladian-style window.

### DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principals of the inventions as illustrated herein, which would occur to one skilled in the relevant art and having possession of this disclosure, are to be considered within the scope of the invention.

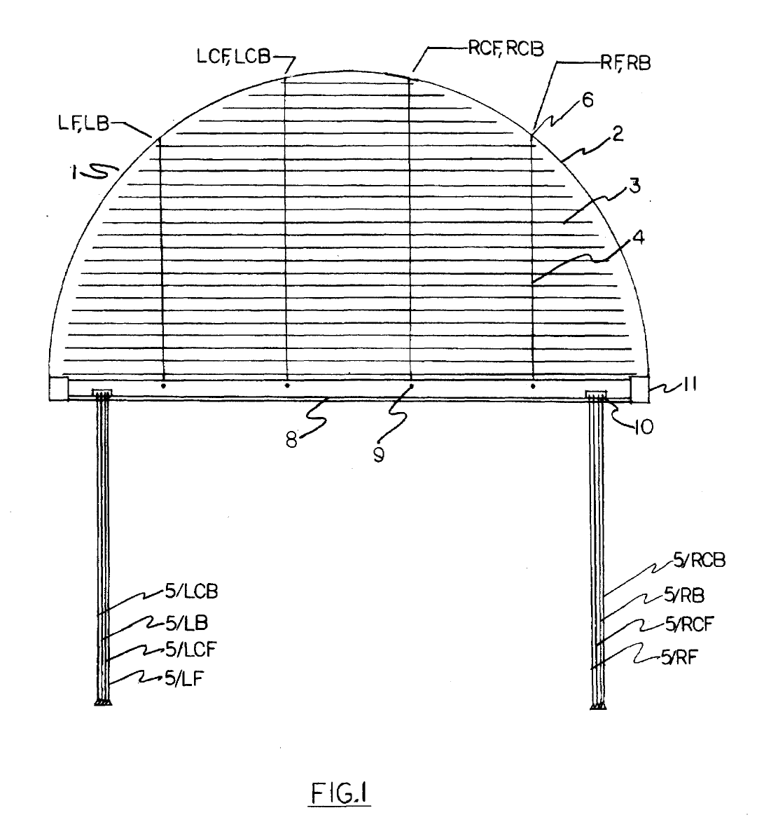

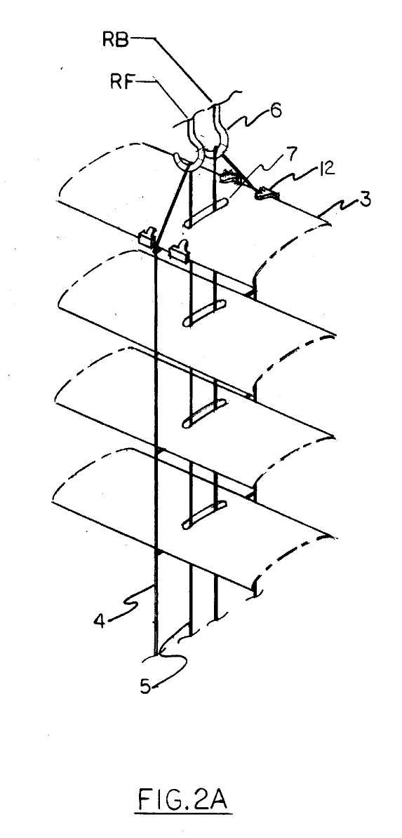

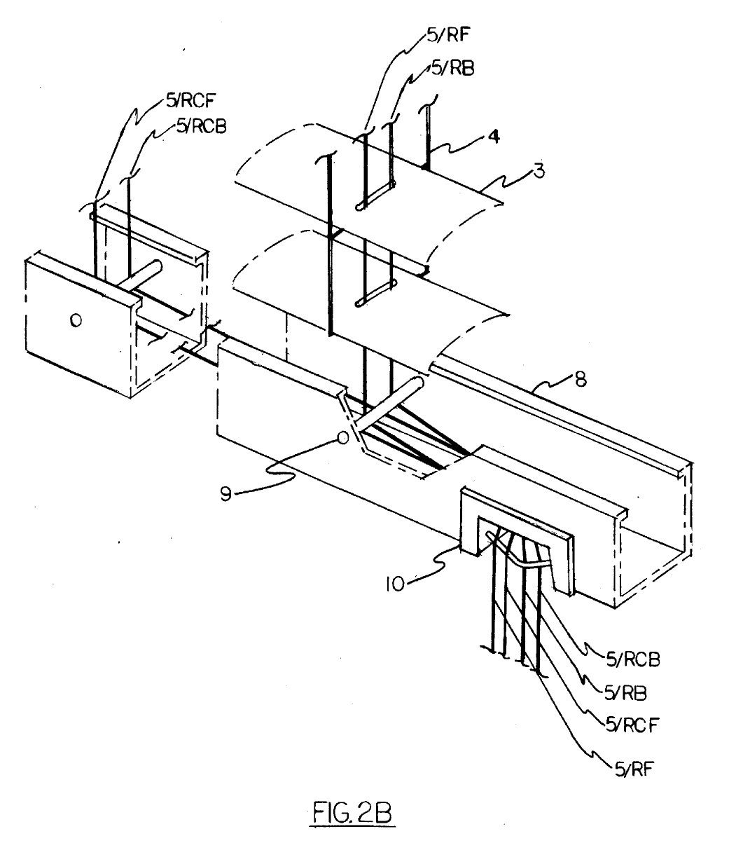

FIG. 1 is a front view of a preferred embodiment of the invention. It shows a Venetian blind 1 for a palladian-style window 2. The blind is shown in the raised position, and installed inside the window frame. The blind construction is the same as that well known in the art. The blind is comprised of a plurality of conventional horizontal slats 3, made of conventional plastic, metal, or wood material. The lengths of the slats are trimmed, with scissors, shears, knives, or any suitable method, to fit the contour of the window 2, and to provide clearance with the window frame when the slats are tilted to vary the amount of light transmitted. The slats are suspended by a plurality of conventional venetian blind cord ladders 4. The number of ladders needed and their spacing is determined by the shape of the window, versus the need to adequately support the slat spans and ends, to prevent sag or droop. Typically, in the popular one inch mini-blind industry, the maximum slat span between cord ladders is twelve inches, and the maximum slat end overhang is five inches. The cord ladders are attached to, or woven integrally with, pull-cords 5, suspended from the top of the window frame with attachment means 6. As illustrated in FIGS. 2A & 2B, the pull-cords 5 are routed over the attachment means 6, and back down through the slat cord slots 7 to a base rail 8. The base rail 8 is a conventional head rail modified to include pivot points 9 at each attach point location, and to include conventional releasable pull-cord locking devices 10 at both ends. The pull-cords 5 are routed around the pivot points 9 and out through the locks 10. The base rail is attached to the bottom of the window frame with conventional brackets 11. For illustration purposes, the attach points are designated; LF, left front; LB, left back; LCF, left center front; LCB, left center back; RCF, right center front; RCB, right center back; RF right front; and RB, right back. The pull-cords 5 corresponding to those locations are indicated with the same lettering.

FIG. 2A is a partial perspective view of the upper portion of the blind at a typical attach point RF, RB, enlarged to clarify details. A conventional screw hook, like those commonly used to hang roll-up bamboo-type blinds, is shown as the means 6 to attach the blind to the window frame, but any suitable means of attachment may be used. A pulley/roller, or any friction reducing device may be desirous to prevent pull-cord 5 wear, and to provide for ease of operation. A conventional slat cord clip 12 is used on the upper most slat to provide stability and to prevent pull-cord 5 slippage.

FIG. 2B is a similar partial perspective view of the corresponding lower portion of the blind at the same attach point RF, RB, again enlarged to clarify details. Also for clarification, a section of the base rail 8 is broken out, and part of the lower portion at attach point RCF, RCB is shown. The pivot points 9 shown may be dowels/rollers made of metal, plastic, or any suitable material. Again, a rotating, friction reducing device would be desirous to prevent pull-cord wear, and to provide for ease of operation.

The details of the blind in FIG. 1 at attach points LF,LB and LCF,LCB are the same as above except reversed as a mirror image.

Referring to FIGS. 1, 2A, & 2B, the blind may be operated as follows. In order to vary the amount of light transmitted, the blind slats can be tilted forward by releasing the pull-cords 5 at the locks 10 and pulling the pull-cords 5 at locations RF,RCF,LF, & LCF simultaneously. Similarly, the blind slats can be tilted rearward by releasing the pull-cords 5 at locks 10 and pulling the pull-cords 5 at locations RB,RCB,LB, & LCB simultaneously.

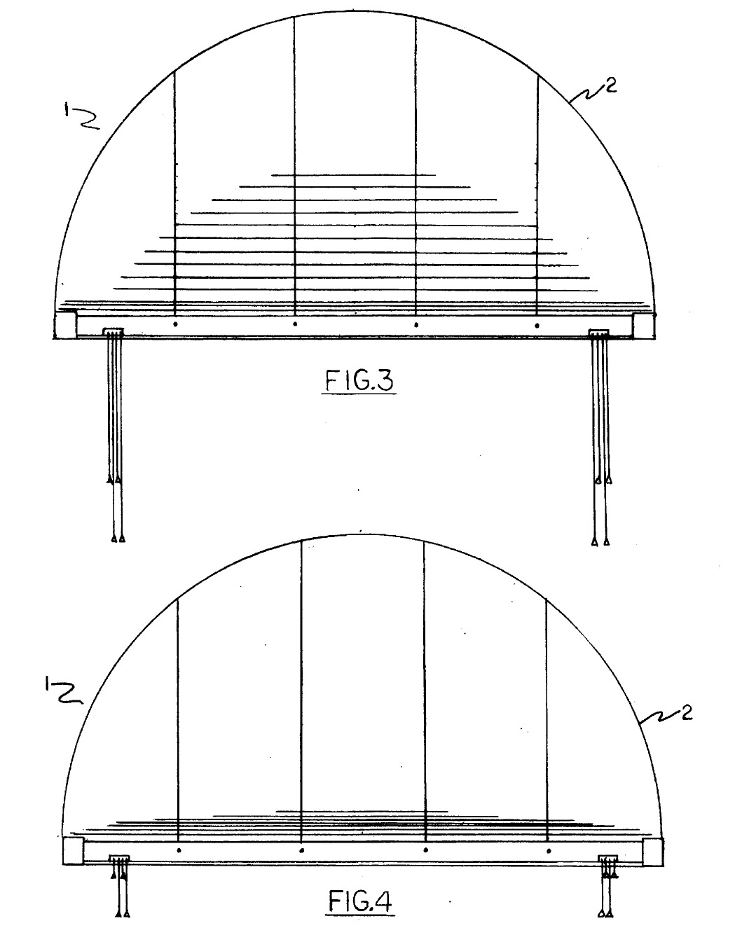

The blind in FIG. 1 is shown in the raised position. The blind can be lowered by releasing all pull-cords 5 at locks 10, thereby allowing the blind to be lowered by gravity or by hand. The blind is shown in mid-position in FIG. 3, and fully lowered in FIG. 4. In the fully lowered position, maximum light transmission or visibility is provided for. Or, in this position, the pull-cords 5 can be slipped off the attachment means 6 to allow access to the window for cleaning or maintenance. After the pull-cords are reattached to the attachment means, the blind can be returned to the raised position, shown in FIG. 1, by pulling all of the pull-cords 5 simultaneously. The slats can be leveled by pulling the pull-cords 5 designated RCB,RB,RCF, & RF simultaneously to raise the right side, or by pulling the pull-cords 5 designated LCB,LB,LCF, & LF simultaneously to raise the left side.

It can be seen by anyone skilled in the art that the above described method of routing the pull-cords 5 in the base rail 8, and locking/releasing the pull-cords 5 with the lock 10, is not critical to the intent of this invention. For instance, all of the pull-cords 5 could be routed to the right side of the blind, or to the left side of the blind. Or, the lock 10 could be eliminated and the cords simply stopped by wrapping them around a cleat, fixed to the window frame or wall, as is often done with roll up bamboo-type shades.

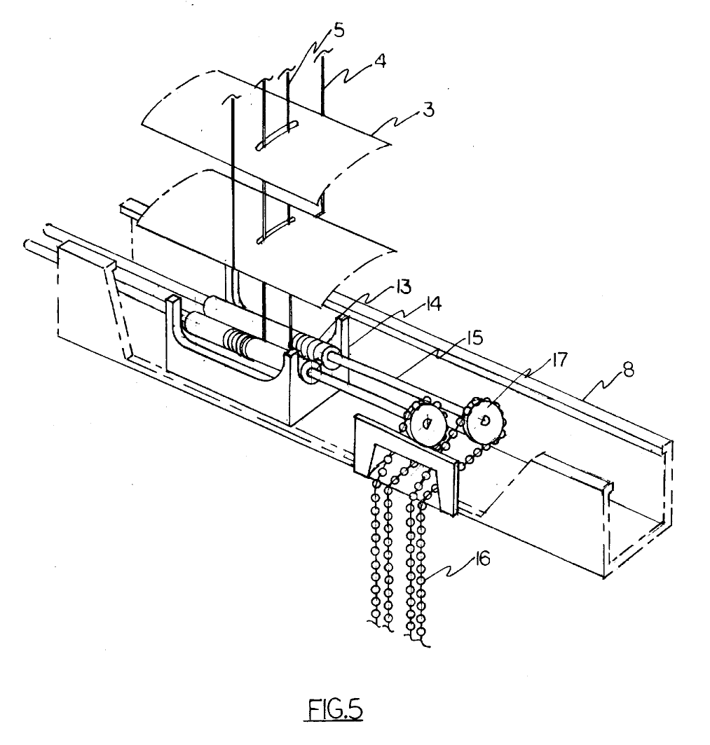

Additionally, anyone skilled in the art can see that means, other than pulling the cords by hand, can be used to tilt and raise/lower the blind. FIG. 5 is an enlarged, partial, perspective view of the lower portion of another embodiment of the invention at a typical attach point, with a section of the base rail broken out for clarification. similar to view 2B. In this embodiment of the invention the pull-cords 5 are attached to drums 13, mounted in cradle 14, situated in base rail 8, driven by tilt rods 15, and rotated by continuous loop beaded chains 16, seated on corresponding pulleys 17. Items 13, 14, 15, 16, and 17 are modified versions of conventional blind tilt mechanisms well known in the industry. With the pull-cords 5, of sufficient length to permit raising and lowering, and wrapped on the drums 13 in opposing directions; pulling on the chains 16 to rotate the drums in the same direction, either clockwise or counter-clockwise, will tilt the slats 3 forward or rearward. Pulling on the chains in opposite directions, either clockwise or counter-clockwise, will raise or enable lowering the blind by gravity, or by hand. The tilt rods 15 will torsionally transmit the rotation to each ladder 4 attach point location. Alternatively, it can be seen by anyone skilled in the art, that the beaded chain/pulley mechanism could be replaced by a modified conventional wand tilt-gear mechanism, such as items 20 and 21 shown in FIG. 7.

Both of the above descriptions refer to a blind in which the slats can be tilt adjusted, and the blind can be raised or lowered. Since this blind would be more complex to manufacture, it would also be more expensive. In some cases, there may be no desire to raise or lower the blind, or to adjust the slat tilt; an arched palladian-style window over a doorway being one possible example.

FIG. 6 shows another embodiment of the invention comprising a partially adjustable blind 18 capable of being slat tilt adjusted, but incapable of being raised and lowered. FIG. 7 shows the pull-cords 5 routed down through the top of a base rail 19, a conventional blind head rail, and attached to a conventional wand tilt-gear mechanism 20. The base rail 19 is attached to the bottom of the window 2 frame with conventional brackets 11. At the top of the cord ladders 4, the pull-cords 5 are routed over the attachment means 6 as shown in FIG. 2A. The slats 3 may be tilt adjusted, forward or rearward, by rotating the wand 21 on the wand tilt-gear mechanism 20, clockwise or counter clockwise. The ability to use an off-the-shelf conventional blind head rail, would minimize the cost of this embodiment of the invention.

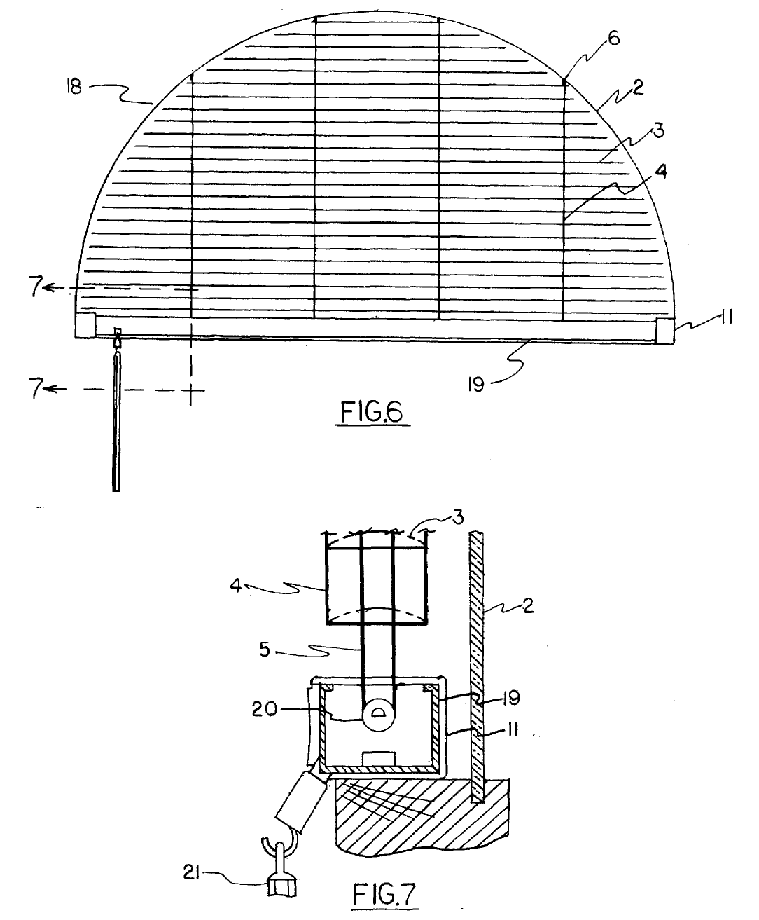

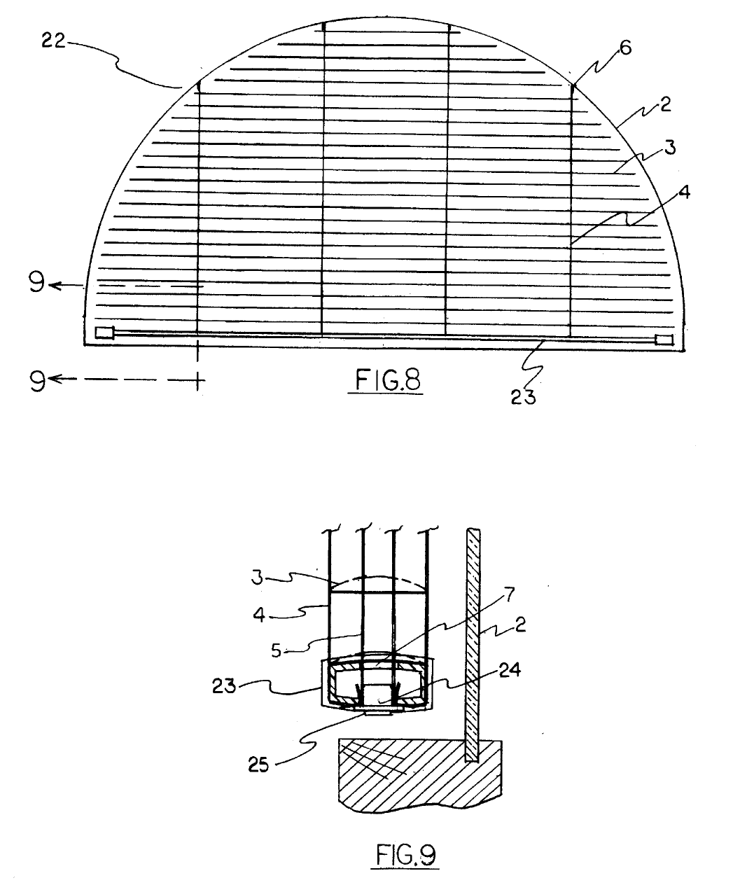

FIG. 8 shows another embodiment of the invention comprising a static or non-adjustable blind 22; i.e. incapable of being tilted, or raised and lowered. FIG. 9 shows the pull-cords 5 routed down to a bottom rail 23. The bottom rail 23 is a conventional bottom rail modified as shown to include a cord slot 7 and button hole 24 at each cord ladder 4 location. As shown, the button 25 secures the pull-cords 5, externally to the bottom rail 23; and the cord ladder 4, internally to the bottom rail 23. At the top of the cord ladders 4, the pull-cords 5 are routed over the attachment means 6 the same as shown in FIG. 2A.

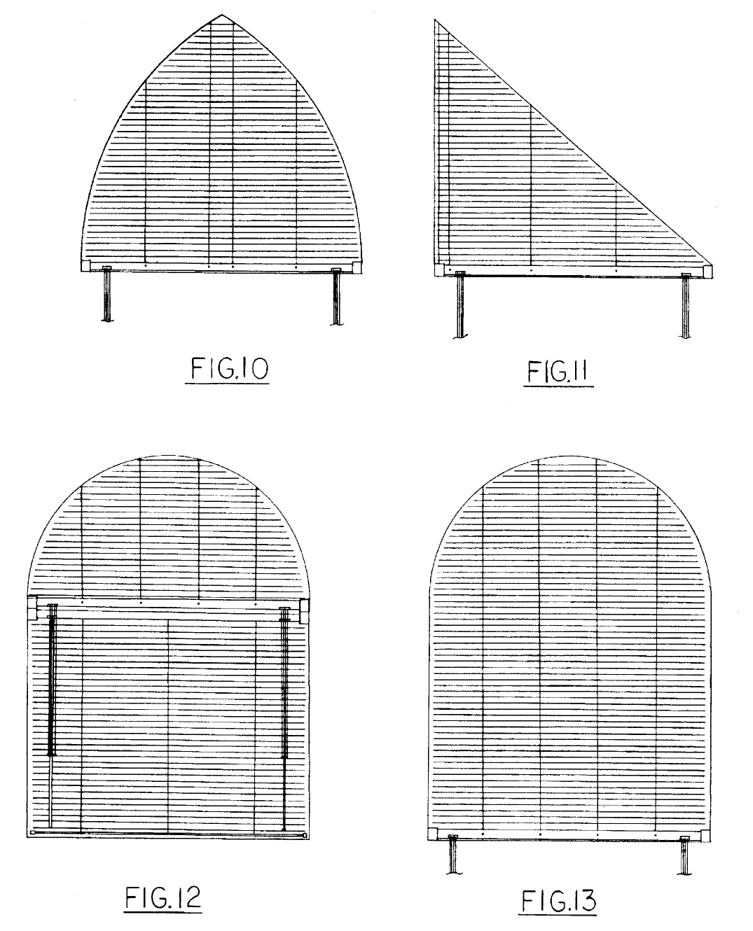

All of the above embodiments disclose a venetian blind for installation inside the frame of a window with an arched top. Anyone skilled in the art can see that the blind can also be installed on the front of the window frame with the addition of suitable brackets to which to mount the attach points, the base rail brackets 11 being multi-positional. Also, it can readily be seen that the blind is not limited to use with an arched window, but that it can be made to cover many irregularly shaped windows. Two examples are FIG. 10, an arched, church-type window, and FIG. 11, a slanted top, chalet-type window. Further, it can be seen that the blind can be made to cover only the irregularly shaped portion of a window, or extended downward to cover the regular portion also, if one exists. FIG. 12 illustrates a palladian-style window with the present invention covering the irregular portion of the window, and a conventional venetian blind covering the regular portion of the window. FIG. 13 illustrates an embodiment of the present invention covering the irregular portion of the window, and extended downward to cover the regular portion of the window.

It is to be understood that the above referenced arrangements are illustrative of the application of the principles of the present invention. It will be apparent to those of ordinary skill in the art that numerous modifications can be made without departing from the principles and concepts of the invention as set forth in the claims.

What is claimed is:

1. A venetian blind for an irregularly shaped window, comprising:
a plurality of slats, trimmed to fit the contour of said window;
cord ladders to support said slats, of sufficient quantity, and properly spaced, to prevent sag of said slat spans, or droop of said slat ends;
means to attach said blind to the top of the window frame at each said cord ladder location;
pull-cords attached to said cord ladders, to suspend the cord ladders from said attachment means, and routed down through slat cord-slots to;
an adjustment means contained in a base rail attached to the bottom of said window frame.

2. A blind as in claim 1 wherein said attachment means is a screw hook.

3. A blind as in claim 1 wherein said attachment means is comprised of a rotating, friction reducing device.

4. A blind as in claim 1, capable of having said slats tilted forward or rearward, and capable of being raised or lowered, wherein said adjustment means is comprised of:
said pull-cords routed around pivot points, mounted in said base rail at each said cord ladder location, and routed to;
a locking means.

5. A blind as in claim 4 wherein said locking means is comprised of a releasable pull-cord locking device.

6. A blind as in claim 4 wherein said locking means is a fixed cleat.

7. A blind as in claim 1, capable of having said slats tilted forward or rearward, and capable of being raised or lowered, wherein said adjustment means is comprised of:
each said pull-cord fastened to, and wrapped, in opposing directions, around;
separate, parallel drums, seated in;
cradles, mounted in;
said base rail, at said cord ladder locations, and connected by;
separate, parallel tilt rods, rotated by;
a torquing means.

8. A blind as in claim 7 wherein said torquing means are continuous beaded chains, seated on corresponding pulleys, fixed to said tilt rods.

9. A blind as in claim 7 wherein said torquing means are wand tilt-gear mechanisms, containing said tilt rods.

10. A blind as in claim 1, capable of having said slats tilted forward or rearward, wherein said adjustment means is comprised of:
said pull-cords attached each to opposite sides of;
drums, seated in;
cradles, mounted in;
said base rail, at said cord ladder locations, and connected by;
a tilt rod, rotated by;
a wand tilt-gear mechanism.

11. A non-adjustable venetian blind for an irregularly shaped window, comprising:
a plurality of slats, trimmed to fit the contour of said window;
cord ladders to support said slats, of sufficient quantity, and properly spaced, to prevent sag of said slat spans or droop of said slat ends;
means to attach said blind to the top of said window frame at each said cord ladder location;
pull-cords attached to said cord ladders, to suspend said cord ladders from said attachment means, and routed down through slat cord-slots to;
a bottom rail, to which said pull-cords and said cord ladders are affixed with;
a button.

12. A blind as in claim 1 wherein said window has a curved top frame.

13. A blind as in claim 1 wherein said window has a straight, non-horizontal top frame.

14. A blind as in claim 1 wherein said window has an irregularly shaped upper portion, and a regularly shaped lower portion, and said blind further comprises a downward extension, so as to cover both the irregular and regular portions of the window.

15. A blind as in claim 1 wherein said blind is installed inside said window frame.

16. A blind as in claim 1 wherein said blind is installed outside said window frame by means of brackets attached to the front of said window frame.

17. A venetian blind for an irregularly shaped window, comprising:
a plurality of slats, trimmed to fit the contour of said window;
cord ladders to support said slats, of sufficient quantity, and properly spaced, to prevent sag of said slat spans, or droop of said slat ends;
means to attach said blind to the top of said window frame at each said cord ladder location;
pull-cords attached to said cord ladders, to suspend said cord ladders from said attachment means, and routed down through slat cord-slots to;
an adjustment means contained in a base rail attached to the bottom of said window frame;
wherein said blind is capable of being raised or lowered, or of having said slats tilt adjusted; is suitable for installation in an irregularly shaped window with a curved or straight, non-horizontal top frame; is suitable for installation in a window with both irregularly and regularly shaped portions; and is suitable for installation inside or outside of said window frame.
